(19) United States
(12) Patent Application Publication
(10) Pub. No.: US 2016/0014443 A1
(43) Pub. Date: Jan. 14, 2016

(54) BROADCASTING OF LAND, WATER, AND AIR CAMERAS

(71) Applicant: UMM AL-QURA UNIVERSITY, Makkah (SA)

(72) Inventor: Saleh Abdullah Saleh Al Salameh, Al Rass (SA)

(73) Assignee: UMM AL-QURA UNIVERSITY, Makkah (SA)

(21) Appl. No.: 14/373,465

(22) PCT Filed: Jul. 8, 2014
(86) PCT No.: PCT/IB14/01299

§ 371 Date: Jul. 21, 2014

(51) Int. Cl. H04N 21/4223; H04N 21/414; H04N 21/218; H04N 21/2187; H04N 5/247; H04N 21/214

(52) U.S. Cl. CPC H04N 21/4223; H04N 5/247; H04N 21/2146; H04N 21/21805; H04N 21/2187; H04N 21/41422

(57) ABSTRACT

A camera viewing system and method includes a first array of cameras distributed atop a carrier to record or stream video content about a radial view of the carrier. A second array of cameras distributed about a first side of the carrier records or streams video content from a front and back first side view of the carrier. A third array of cameras distributed about a second side of the carrier records or streams video content from a front and back second side view of the carrier. A router routes the recorded and streamed video content to the carrier, and a transmitter transmits the recorded and streamed video content to a satellite for routing to a receiver for subsequent display away from the carrier. A plurality of displays receives camera manipulation instructions from multiple parties and displays associated results, via respective GUIs.

### BACKGROUND OF THE INVENTION

Advances in technology have provided a full gamut of recording options for many different purposes. Travel is one of the most popular events to be recorded. However, photographing or video recording from a commercial carrier, especially an air carrier is limited. Many times, the recorded images are blurred, have a reflection from a window, or are too far away to capture the image of interest. In addition, a passenger's view of an interesting object or feature may be blocked or out of sight.

Maintenance or operational personnel of a commercial carrier are under similar limitations of having a partially or completely blocked view of operational items of interest. Many times, a mechanical or operational problem is not known until the damage is severe, which could cause major delays and safety issues.

### SUMMARY OF THE INVENTION

Embodiments include a camera viewing system, which includes a first array of cameras distributed atop a carrier that is configured to record or stream video content about a radial view of the carrier. The camera viewing system also includes a second array of cameras distributed about a first side of the carrier that is configured to record or stream video content from a front and back first side view of the carrier. The camera viewing system also includes a third array of cameras distributed about a second side of the carrier that is configured to record or stream video content from a front and back second side view of the carrier. The camera viewing system also includes a router configured to route the recorded and streamed video content to the carrier, and a transmitter configured to transmit the recorded and streamed video content to a satellite for routing to a receiver for subsequent display away from the carrier. The camera viewing system also includes a plurality of displays configured to receive camera manipulation instructions from multiple parties and display associated results, via respective graphical user interfaces (GUIs).

Embodiments also include a redundant camera viewing system, which includes a first array of cameras distributed atop a carrier that is configured to record or stream video content about a radial view of the carrier. The redundant camera viewing system also includes a second array of cameras distributed about a first side of the carrier that is configured to record or stream video content from a front and back first side view of the carrier. The redundant camera viewing system also includes a third array of cameras distributed about a second side of the carrier that is configured to record or stream video content from a front and back second side view of the carrier. The redundant camera viewing system also includes a router configured to route the recorded and streamed video content to the carrier. The first, second, and third arrays of cameras contain multiple cameras directed towards a similar viewing area, and are configured to capture duplicate video content and assign to individual viewers.

Embodiments also include a method of displaying video content to passengers or personnel of a carrier. The method includes receiving live or recorded video content captured from a plurality of arrays of cameras located about a top and one or more sides of a carrier. The method also includes routing the video content to display screens within the carrier for viewing by the passengers or the personnel of the carrier. The method also includes receiving instructions to manipulate one or more of the cameras from the passengers or the personnel of the carrier, via one or more graphical user interfaces (GUIs). The method also includes sending results of the received instructions to the passengers or the personnel of the carrier on a priority basis, and displaying the results of the received instructions onto the respective GUIs.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A illustrates a commercial passenger aircraft according to one example;

FIG. 1B illustrates different views of a mounted camera according to one example;

FIG. 2 illustrates an exterior view of a commercial passenger aircraft according to one example;

FIG. 3 illustrates a system by which camera images are captured, routed, and broadcast according to one example;

FIG. 4 illustrates various air carriers according to one example;

FIG. 5 illustrates a train and water carrier according to one example;

FIG. 6 is a flowchart for a method of displaying video content according to one example;

FIG. 7 illustrates a layout of modules and communication lines of a camera system according to one example; and

FIG. 8 illustrates exemplary computer hardware used in a camera system according to one example.

Referring now to the drawings, wherein like reference numerals designate identical or corresponding parts throughout the several views.

### DETAILED DESCRIPTION OF THE PREFERRED EMBODIMENTS

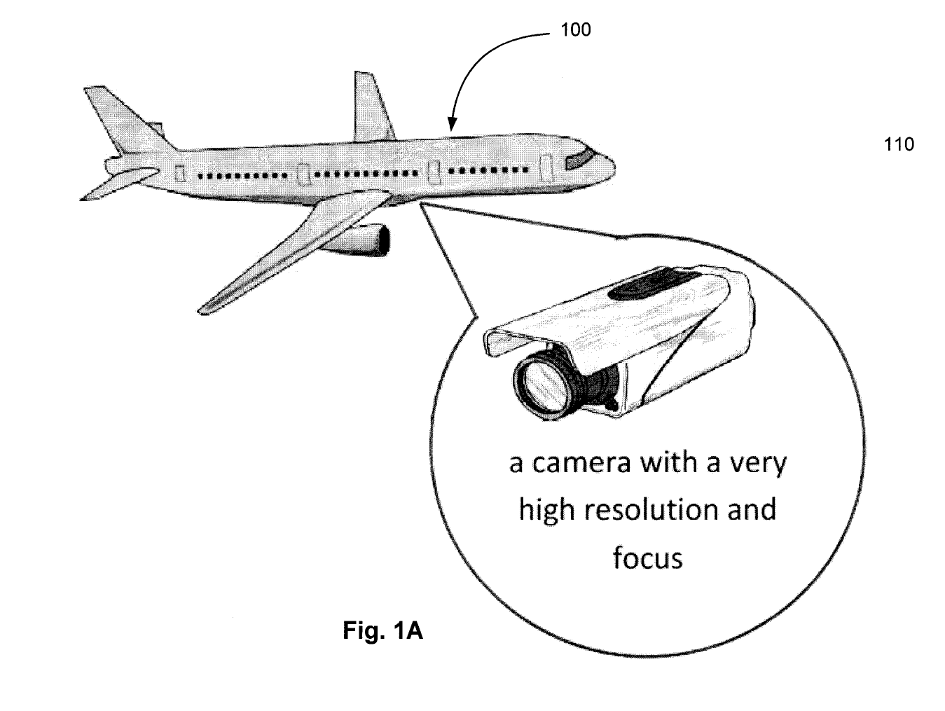

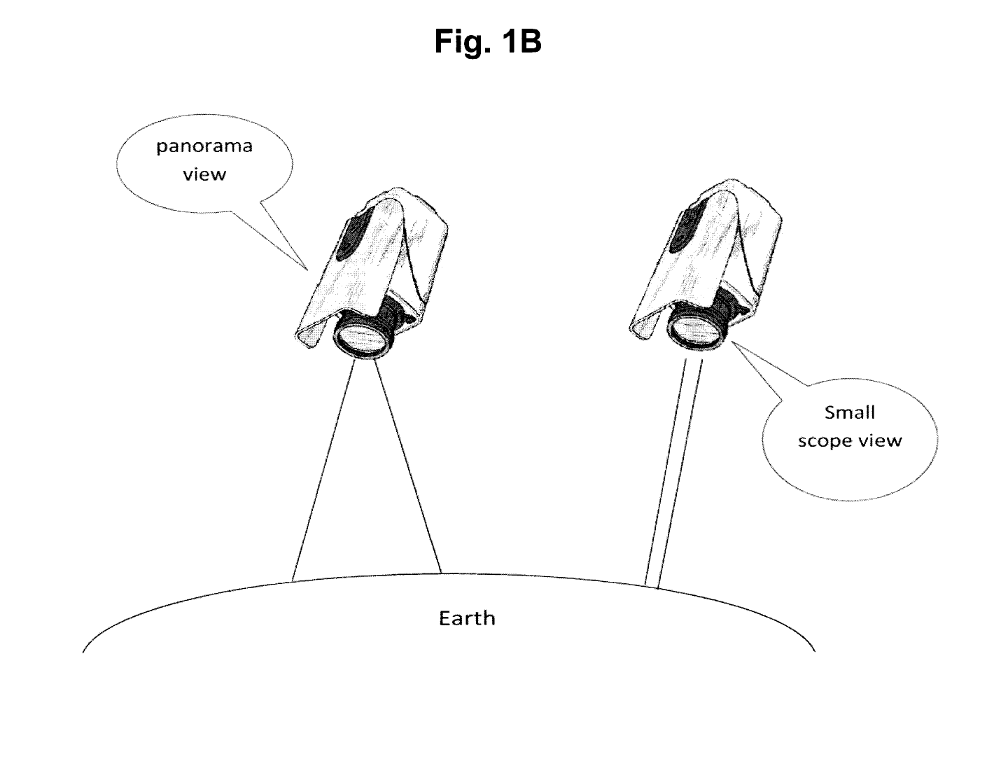

FIG. 1A illustrates a commercial passenger aircraft 100 and an associated camera 110, which has a very high resolution and focus in order to film and record all scenes from different angles of the ground and the sky during a flight from the time of taking off until the aircraft lands. Videos and photographs from a commercial passenger aircraft can be shown to different viewing audiences, including but not limited to flight and ground personnel, riding passengers, advertising agencies, and weather monitoring agencies. The videos and photographs can also be used as evidence in the event of an accident or a crime. FIG. 1A illustrates only one camera 110. However, multiple cameras grouped within multiple camera arrays are mounted at various locations about the commercial passenger aircraft 100, as will be described later. FIG. 1B illustrates that a camera mounted on an underside of a passenger aircraft can capture a panoramic or wide angle view from the aircraft, or a small scope view, either of which can be manually or automatically controlled.

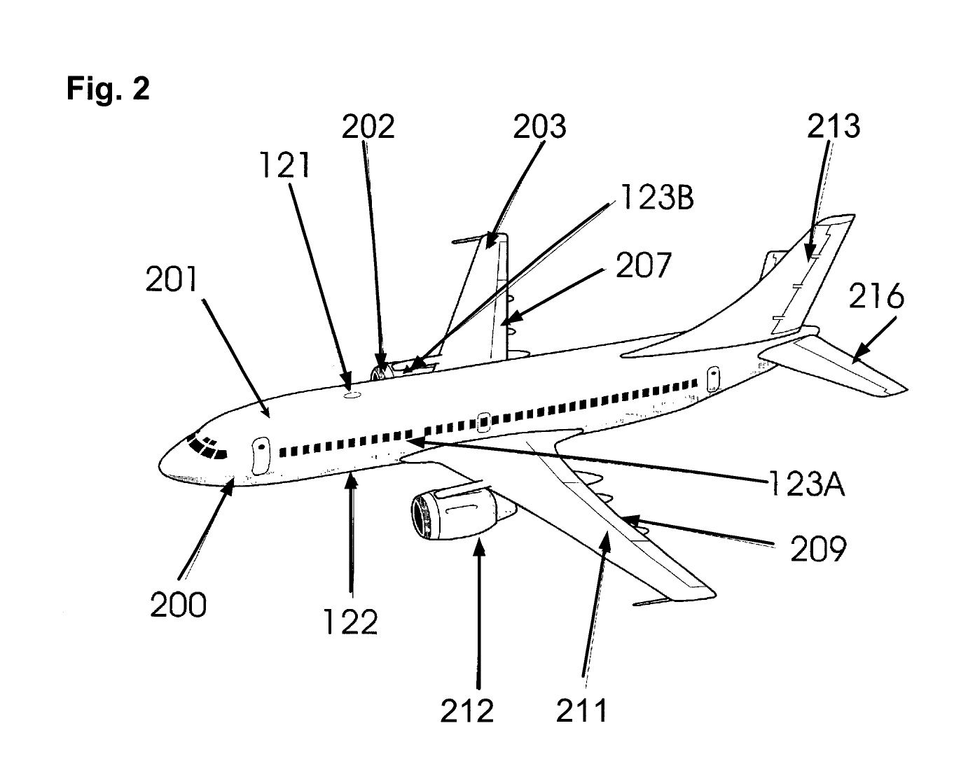

FIG. 2 illustrates an exterior view of a commercial passenger aircraft and the placement of various cameras of a camera viewing system. The passenger aircraft 200 has a generally tubular-shaped fuselage 201. Wings 203 and 211 are mounted on either side of the fuselage 201. Engines 202 and 212 are attached to the underside of each respective wing 203 and 211. Flaps 207 and 209 are located at the back side of each respective wing 203 and 211. A tail 213 and rear stabilizer 216 are located at the back end of the fuselage 201.

A top camera array 121 is mounted on the top of the fuselage 201. A bottom camera array 122 is mounted on the bottom of the aircraft fuselage 201. A side camera array is mounted on each side of the passenger aircraft 200 at 123A and 123B. The side cameras 123A and 123B can be mounted within the passenger cabin. The camera arrays 123A and 123B could also be attached to the fuselage 201. The side camera arrays 123A and 123B are aimed along the leading edge of the wings 203 and 211 to provide a good view of the wings 203 and 211 and engines 202 and 212.

Each camera array 121, 122, 123A, and 123B contains multiple cameras that are aimed or directed at areas of interest. For example, the top camera array 121 may include respective cameras that are directed towards the front of the fuselage 201, towards the rear of the fuselage 201, and towards each side of the fuselage 201 to encompass a complete radial view from the top of the fuselage 201. Embodiments include more than one camera aimed in a particular direction if the four cameras do not cover a complete radial view. The bottom camera array 122 contains at least four cameras to cover views of the front, back, and two sides of the fuselage 201. In addition, a camera could also be aimed or directed downward towards the earth. Side camera arrays 123A and 123B contain at least two cameras to cover a front side view and a rear side view. More than two cameras in each of the side camera arrays 123A and 123B could be included to fully encompass the side views of the fuselage 201. All cameras of the camera arrays could be mounted to a base to provide adjustment of the direction of view of each camera. The combined camera arrays 121, 122, 123A and 123B provide a view of the wings, engines, tail, and other critical components of the aircraft 200.

The top camera array 121 and the bottom camera array 122 could be mounted to the exterior of the fuselage 201. Therefore, the camera arrays would be enclosed within an aerodynamic, durable, and transparent housing. The transparent housing material includes but is not limited to polymethyl methacrylate, hardened glass, acrylic, cellulose acetate butyrate, or polystyrene. The two side camera arrays 123A and 123B may be mounted within the cabin and could be enclosed in a transparent housing.

The cameras may include still-photograph cameras that are timed to capture an image at periodic times. The cameras may also include a camcorder to capture video clips, either continuously or at periodic times. The cameras could be either wire-connected or wirelessly connected to a controlling system, such as a central processing unit. The photographs and/or video clips are captured and routed to be displayed instantaneously for live viewing, and can also be saved for later viewing.

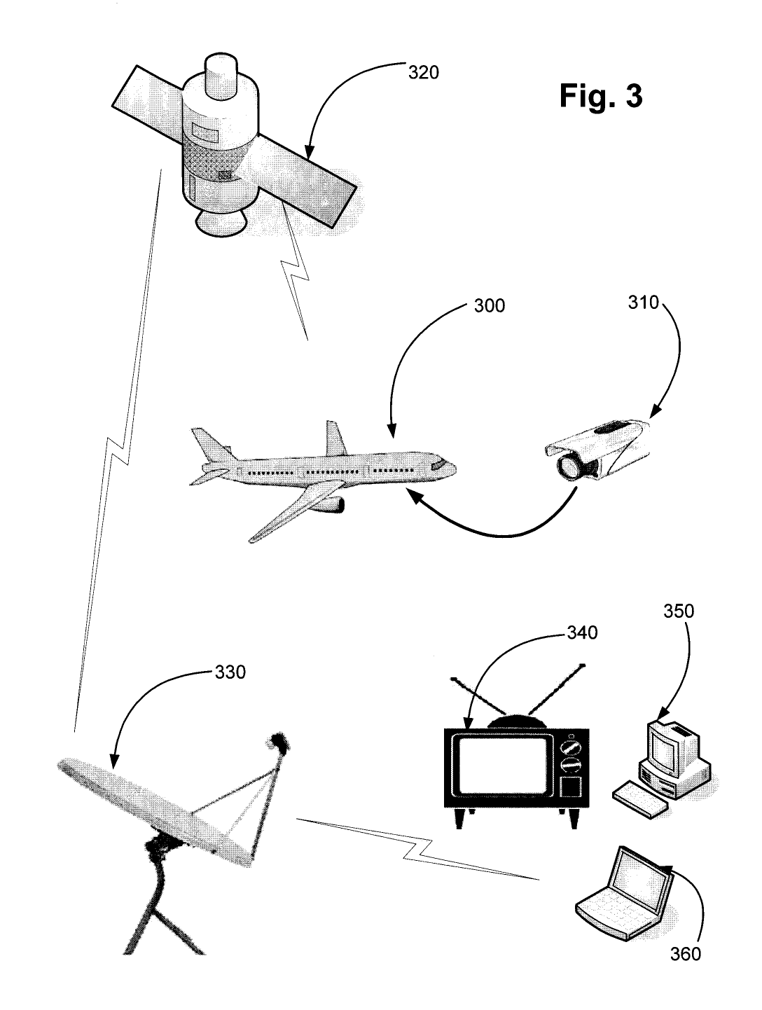

FIG. 3 illustrates a system by which the images are captured, routed, and broadcast. A passenger aircraft 300 has multiple cameras 310 mounted, such as the top, bottom, and side camera arrays described above. The captured photographs and videos are sent to a satellite 320, which routes the captured photographs and videos to a receiver 330 located at or near ground level. The receiver 330 in turn broadcasts the captured photographs and videos to miscellaneous display devices, such as but not limited to a television 340, a desktop computer 350, or a laptop or other mobile computer 360. One or more of the display devices can include an interactive graphical user interface (GUI) for inputting operating instructions and display instructions, as well as receiving display results. The viewing audiences of the received photographs and videos include but are not limited to the airlines company for the particular commercial passenger aircraft, airline governing agencies, such as the Federal Aviation Administration (FAA), weather monitoring agencies, advertising agencies, travel agencies, and mechanical maintenance personnel.

FIG. 3 illustrates images that are captured, routed via satellite to a receiver, and broadcast to various user devices located at or near ground level. Another embodiment would allow passengers to view the images from one or more cameras of interest during a flight, which could be displayed on a monitor on the backside of the seat directly in front of each passenger. A selection of one or more cameras to view can be made individually for each passenger. Selection could be made via a touch screen on a display monitor, as an example. An embodiment could also provide larger mobile screens to passengers for viewing larger and/or multiple images. A connection port could be available for passengers to connect their own mobile devices to the camera views. The images could be live images from any one of the mounted cameras from the camera arrays, or the images could be previously recorded and played back at the passenger's discretion. The multiple images could also be scrolled at a scrolling speed set by the passenger, rather than viewing in split screens or manually scrolling through the images.

Embodiments described herein provide an air carrier passenger with several options during a flight. There may be certain times during a flight that are of more interest than other times. For instance, a flight take-off and a flight landing may be of interest to many passengers, or passing over a major landmark, such as a mountain or a lake. Accordingly, in selected embodiments, passengers may input information indicating which items they are most interested in seeing while on the flight, such as lakes, mountains, baseball stadium, etc, and the system will provide the passenger with this view at the appropriate time during the flight. For example, after the user identifies landmarks or items of interest, the system can determine which of these locations will be in the flight path and at which time based on analyzing geographical data and/or GPS data in conjunction with flight path data as would be understood by on of ordinary skill in the art. The system can then determine when the plane is at a particular location of interest to the user at which point the system will switch to a particular camera to capture the particular view for the passenger. Further, the cameras of the system can be programmed to rotate to a particular location based on timing information received from the passenger or predetermined by the system. For example, a passenger may wish to watch the sunset during their flight and can provide input as to at which time they want a camera to capture the sunset. Alternatively, or in addition to, the system may obtain information in advance as to when sunset occurs during their flight path and either offer this information to the passenger as an optional viewing criterion or can automatically capture the sunset for display to the passengers. Timing information of the sunset or other events can be determined in advance by the system by web crawling particular databases to obtain this information as would be understood by one of ordinary skill in the art.

The multiple images provided by the mounted camera arrays provide multiple views and angles that would not be possible to view directly without the aid of cameras. For example, it is not possible to observe things out of both sides of the aircraft simultaneously. In addition, there is no view for any passenger directly in front of or behind the air carrier. Multiple camera views allow a passenger to see all views and all sides of a feature or event. An interactive display, such as a GUI would allow a passenger to independently select which cameras to view and what order or what display format in which to view them. Another embodiment provides passengers the luxury of viewing recorded features of interest from many perspectives during periods of non-interesting events.

An embodiment also allows passengers to zoom in, via the bottom camera directed downwards, while passing over an area of interest. Passengers could also change the direction of view of other individual cameras, as well as zoom in and out. Still another embodiment would provide passengers the option of downloading an application onto a mobile smart device that will save selected images onto the mobile device for viewing after the flight. These and other viewing selections could be made via a GUI that is allocated to each passenger.

An advertising or marketing agency could also capitalize on airline cameras capturing still photographs or videos while passing over an area of interest. An embodiment includes photographing certain landmark features of a city for purposes of displaying the captured photographs or videos to riding passengers. For example, captured photographs of the white house and the capitol building while flying over Washington, DC could be displayed to riding passengers. This could be a marketing arrangement made between the airlines company and the Chamber of Commerce of Washington, DC. Another embodiment includes capturing photographs of displayed billboards while flying over a particular area, as arranged between the airlines company and the entity responsible for the displayed billboard. The captured billboard photographs could be spot-displayed to flying passengers at the beginning or during display of non-advertising video content. Further, information know about the passengers, such as travel habits, travel locations and expenditures, could be utilized to filter billboards detected by the captured by the airline cameras such that targeted billboard or advertising information could be sent to particular customers which a higher chance of having a marketing effect.

Flight personnel on the commercial passenger aircraft during a flight may also be interested in the captured photographs and videos. Flight personnel could have a continuous or frequently updated live view of the aircraft from the front to the rear of the aircraft and from the upper side and from the lower side of the aircraft. Therefore, any abnormalities could be quickly spotted and dealt with accordingly. The multiple images could be displayed simultaneously to provide an instant picture of the entire aircraft, or the multiple images could be scrolled onto a monitor for viewing one at a time. In addition, each camera could be manually adjusted in terms of projection view and zooming in or out to obtain a better view of a particular feature of interest.

Manipulation of some of the cameras by selected passengers would be possible during certain times of the flight. Any of the cameras would need to be “reserved” for manipulation, since any one camera could not be manipulated by multiple users. A distribution of available cameras could be made on a priority basis, ticket basis (first-class versus economy), and/or payment basis. In selected embodiments, the distribution of camera time can be determined based on who booked the flight first, how often the passenger has flown with a particular airline and/or whether the passenger is a member of the airline or airline program. Further, it is envisioned that games may be played on the GUI consoles within planes and that passengers may play games against each other for fun. Accordingly, the distribution of camera time can also be determined based on winners or losers of various in-flight games. In addition, certain cameras that are primarily used by flight and ground crews may only be available intermittently for passenger viewing. One or more of the cameras could be assigned for individual use, including but not limited to passengers, flight personnel, ground personnel, certain agency users, government users, or private company users.

Redundant cameras could be made a part of the camera viewing system to alleviate some or all of the above-described problems. For example, the airlines may want a dedicated viewing of at least some of the cameras, without them being manipulated by any of the passengers. Redundant cameras could provide multiple cameras with the same or similar viewing area to multiple audiences. For example, some cameras with a similar view could be configured and/or programmed for carrier personnel use, while other cameras with the similar view could be configured and/or programmed for passenger use. This would allow independent manipulation of multiple cameras by multiple audiences of the same or similar viewing area. The number of redundant cameras could be determined based upon a market demand.

Weather monitoring agencies may also want dedicated cameras to capture all views from all angles. In addition, weather monitoring agencies could mount other measuring devices to be used with the recorded images, such as pressure, temperature, and wind-measuring devices. Natural phenomena, such as flooding or a volcano could also be monitored by a weather monitoring agency or other agency. Redundant cameras could also provide backup images during any down time of certain cameras. Certain agencies, such as travel agencies or advertising agencies may want a combination of their own dedicated cameras, plus the option of using any passenger recorded events. Law enforcement agencies could use some of the video content in solving a crime. Aviation government agencies could use some of the video content to obtain information from a downed air carrier.

A large number of redundant cameras would provide the option of passenger manipulation of the cameras to a large number of passengers, rather than just a select few, such as first-class passengers. Different options would be available to an air carrier to provide camera viewing to most or all of its passengers, with or without a fee. In addition, one or more cameras could be reserved with the purchase of a ticket. Also, certain cameras could be owned or leased by a particular person or agency. During a flight, those owned or leased cameras could be operated by an employee or contractor of the respective agency.

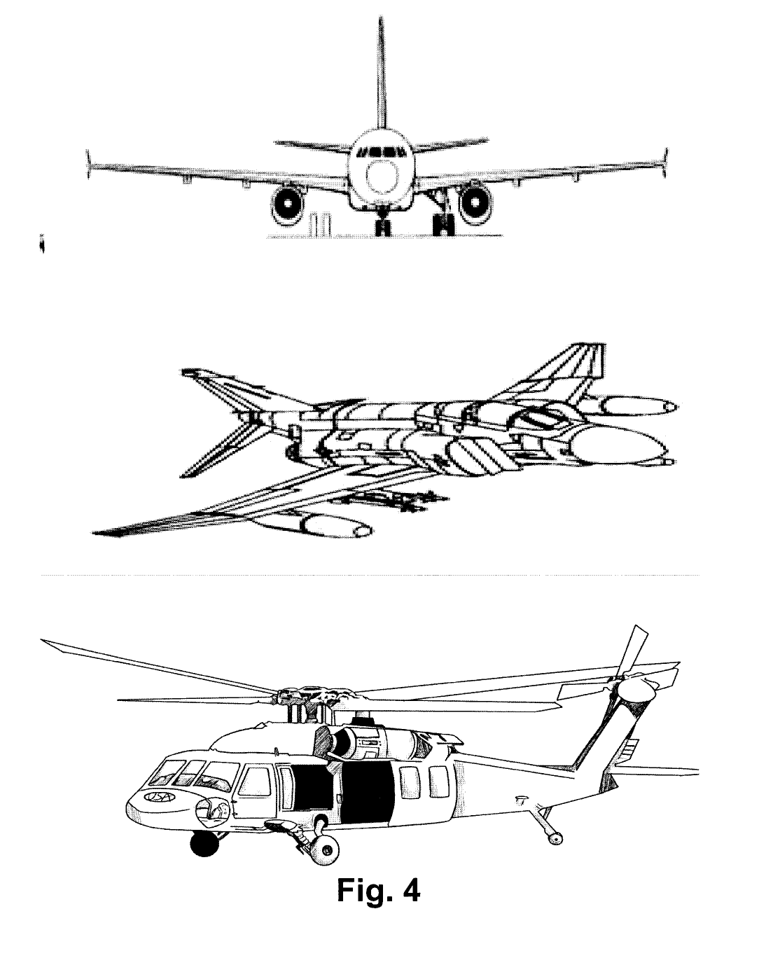

Embodiments described above have been described in the context of a commercial air carrier with public or private passengers. However, any air carrier could be used to implement embodiments described herein. For example, a weather agency, news agency, or law enforcement agency may own the air carrier, in addition to the mounted cameras and any other related equipment or measuring devices. Air carriers illustrated in FIGS. 1-3 are some examples. Other air carriers include but are not limited to airplanes, helicopters, and military aircraft, such as the aircraft vehicles illustrated in FIG. 4. Embodiments described herein could be used in various military air carriers for surveillance purposes, such as fighter jets or drones. Other air carriers include unmanned aerial vehicles, un-motorized aerial vehicles, remote controlled aerial vehicles, and hot air balloons.

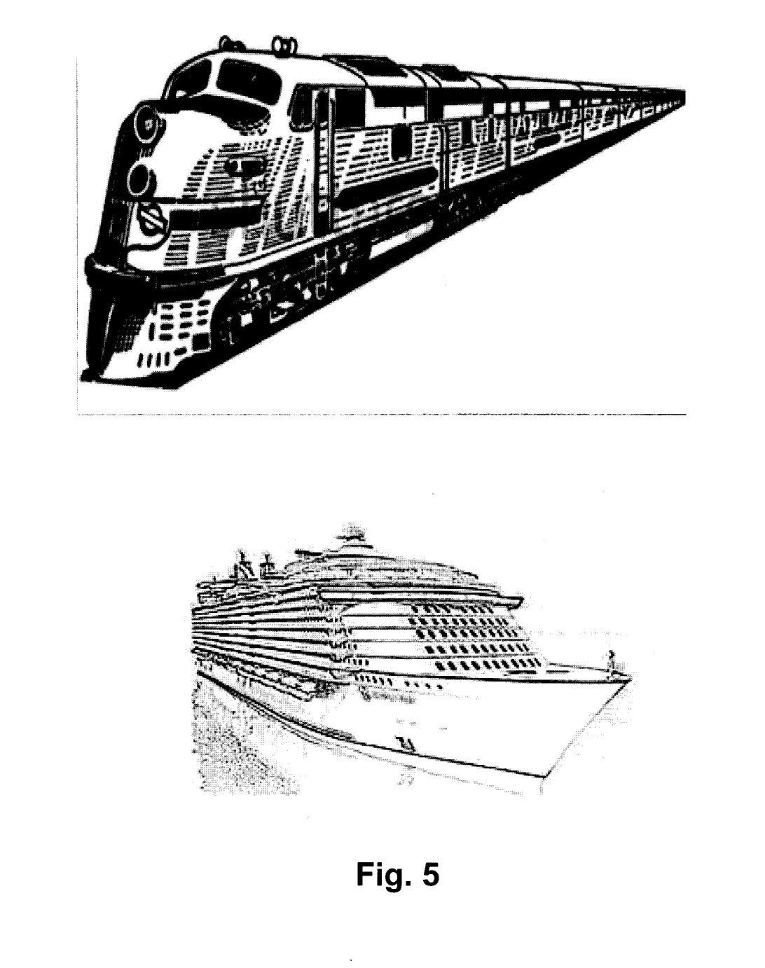

Embodiments described herein can also be used for carriers other than air carriers. FIG. 5 illustrates a passenger train and a passenger cruise-liner. Other examples of passenger carriers include but are not limited to buses and smaller water vehicles. A land or water vehicle may not need a camera aimed directly downwards, such as that used by an air carrier. However, all other mounted cameras, their uses, and their advantages could be realized with a land or water carrier, which are contemplated by embodiments described herein. For example, cameras mounted at different locations at different angles to a train, bus, or ship would provide the advantages of capturing multiple views that would not be possible for an individual to view directly. In addition, commercial trains, buses, and ships or barges could profit from the advantages of enhanced surveillance of the carrier and its mechanical and operational facilities. Captured video images for any carriers could be a live stream of video content and/or replay of recorded video images.

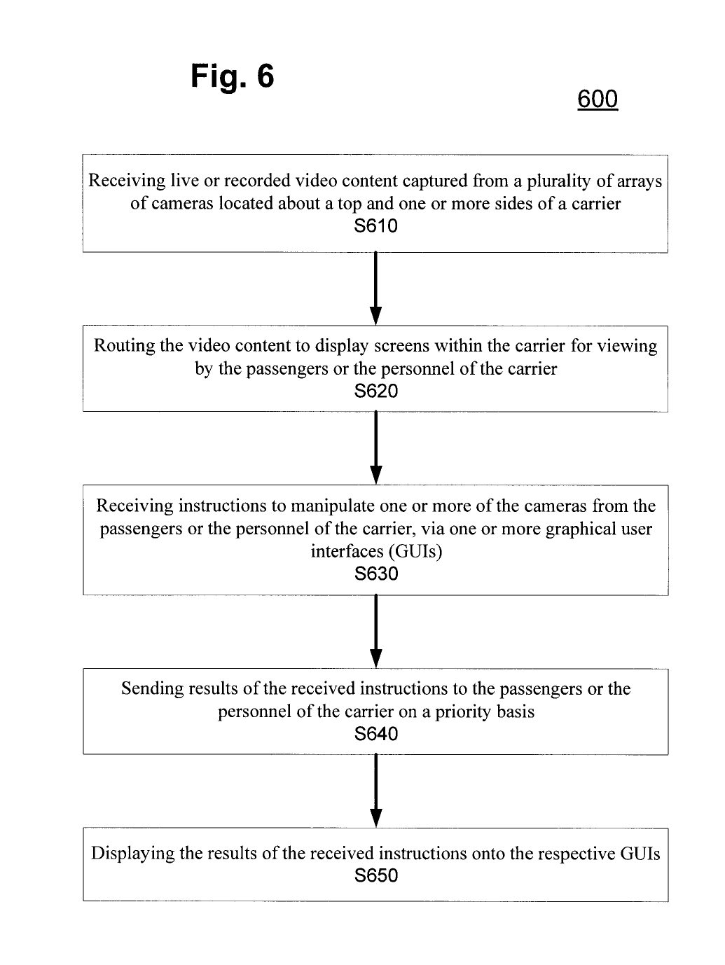

FIG. 6 is a flowchart, which illustrates a method 600 of displaying video content to passengers or personnel of a carrier. Live or recorded video content that is captured from a plurality of arrays of cameras located about a top and one or more sides of a carrier is received in step S610. Live or recorded video content captured from a plurality of arrays of cameras located on a bottom surface of the carrier may also be received. The carrier could be one of an air carrier, a train, a water vessel, or a bus. However, other carriers that incorporate the methods and systems of embodiments described herein are hereby contemplated. The video content is routed to display screens within the carrier for viewing by the passengers or the personnel of the carrier in step S620. Instructions to manipulate one or more of the cameras are received from the passengers or the personnel of the carrier, via one or more graphical user interfaces (GUIs) in step S630. Received instructions could include one or more of changing a camera direction, zooming a camera in or out, streaming live video content, or displaying recorded video content. Results of the received instructions are sent to the passengers or the personnel of the carrier on a priority basis in step S640. The results of the received instructions are displayed onto the respective GUIs in step S650.

The method 600 could also include receiving live or recorded duplicate video content from multiple cameras, and receiving independent instructions to manipulate the multiple cameras receiving the duplicate video content. The method 600 could also include receiving independent instructions to manipulate the multiple cameras from one or more of an advertising agency, a news agency, a law enforcement agency, or a weather agency.

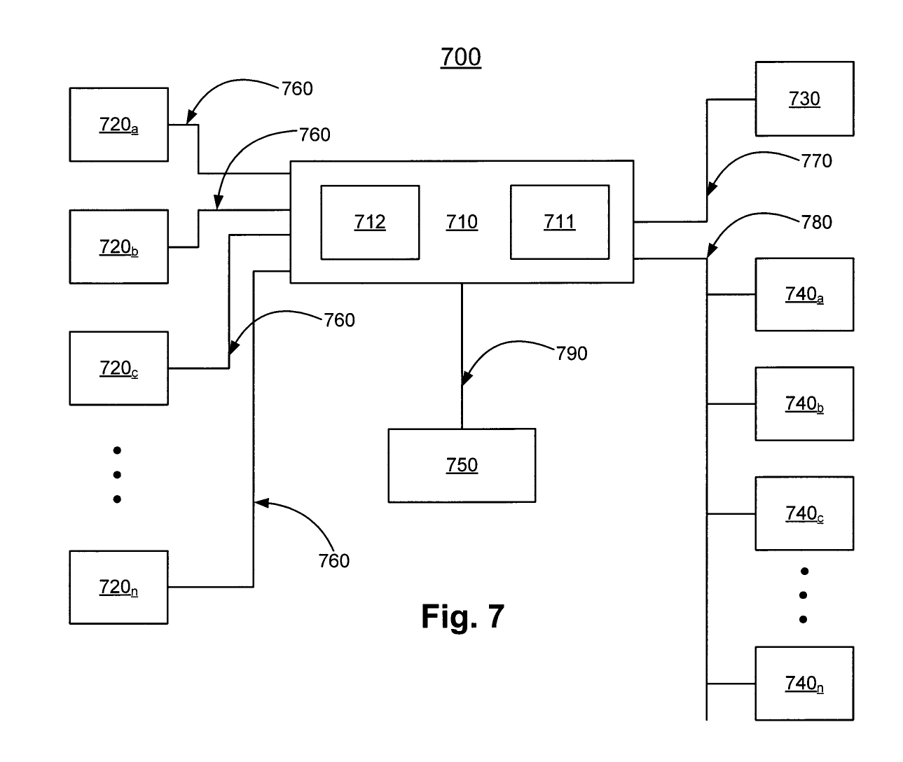

FIG. 7 is an illustration of a layout of modules and communication lines between the modules of a camera system 700 according to embodiments described herein. A central processing unit (CPU) 710 controls the communication between the modules of the camera system 700. The CPU 710 includes a memory component 711, and a router 712. The router 712 routes video content from camera array modules 720 to associated display modules 740. FIG. 7 illustrates multiple camera array modules 720ₐ-720ₙ, which transfer video content to the CPU 710 through associated bus lines 760. The individual camera array modules could represent a camera array located atop a carrier, another two camera arrays could be located on either side of the carrier, and another camera array could be located on the underside of the carrier. However, several other locations and combinations of locations of camera array modules are contemplated by embodiments described herein.

The router 712 routes video content to various display modules, such as display module 730, which could be a dedicated display module, such as a display dedicated to carrier personnel through a bus line 770. The router 712 also routes video content to one or more display modules 740ₐ-740ₙ, which could be display modules intended for passenger viewing through associated bus lines 780. However, other display modules or groups of display modules are contemplated by embodiments described herein. The display modules could be interactive modules, in which instructions could be input and returned results displayed, such as a graphical user interface (GUI). In addition to receiving instructions and displaying results through display modules 740, the video content can be transmitted by a transmitter module 750 to a remote location. An example of a transmission system was illustrated in FIG. 3. Instructions from the CPU 710 to the transmitter module 750 are transferred through communications line 790.

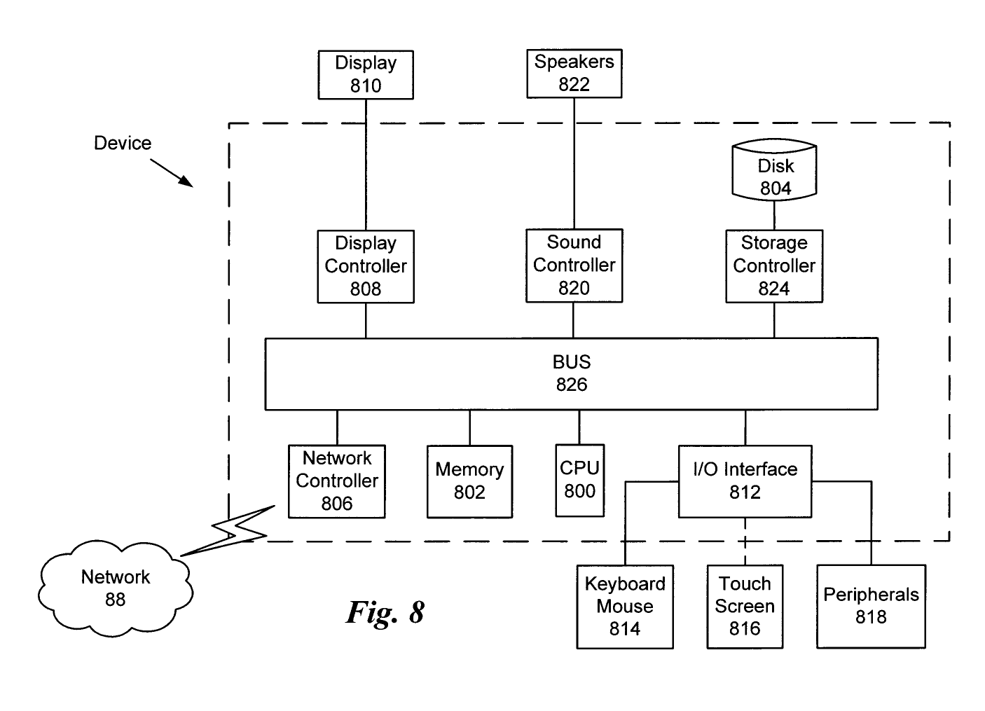

FIG. 8 illustrates exemplary computer hardware used in a camera system according to embodiments described herein. In FIG. 8, the camera system includes a CPU 800 which performs the processes described above. The process data and instructions may be stored in memory 802, which may be separate from or in combination with the memory 711 illustrated in FIG. 7. These processes and instructions may also be stored on a storage medium disk 804 such as a hard drive (HDD) or portable storage medium or may be stored remotely. Further, the claimed embodiments are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the camera system communicates, such as a server or computer.

Further, the claimed embodiments may be provided as a utility application, background daemon, or component of an operating system, or combination thereof, executing in conjunction with CPU 800 and an operating system such as Microsoft Windows 7, UNIX, Solaris, LINUX, Apple MAC-OS and other systems known to those skilled in the art.

CPU 800 may be a Xenon or Core processor from Intel of America or an Opteron processor from AMD of America, or may be other processor types that would be recognized by one of ordinary skill in the art. Alternatively, the CPU 800 may be implemented on an FPGA, ASIC, PLD or using discrete logic circuits, as one of ordinary skill in the art would recognize. Further, CPU 800 may be implemented as multiple processors cooperatively working in parallel to perform the instructions of the inventive processes described above.

The camera system in FIG. 8 also includes a network controller 806, such as an Intel Ethernet PRO network interface card from Intel Corporation of America, for interfacing with network 88. As can be appreciated, the network 88 can be a public network, such as the Internet, or a private network such as an LAN or WAN network, or any combination thereof and can also include PSTN or ISDN sub-networks. The network 88 can also be wired, such as an Ethernet network, or can be wireless such as a cellular network including EDGE, 3G and 4G wireless cellular systems. The wireless network can also be WiFi, Bluetooth, or any other wireless form of communication that is known.

The camera system further includes a display controller 808, such as a NVIDIA GeForce GTX or Quadro graphics adaptor from NVIDIA Corporation of America for interfacing with display 810, such as a Hewlett Packard HPL2445w LCD monitor. A general purpose I/O interface 812 interfaces with a keyboard and/or mouse 814 as well as a touch screen panel 816 on or separate from display 810. General purpose I/O interface 812 also connects to a variety of peripherals 818 including printers and scanners, such as an OfficeJet or DeskJet from Hewlett Packard.

A sound controller 820 is also provided in the camera system, such as Sound Blaster X-Fi Titanium from Creative, to interface with speakers/microphone 822 thereby providing sounds and/or music.

The general purpose storage controller 824 connects the storage medium disk 804 with communication bus 826, which may be an ISA, EISA, VESA, PCI, or similar, for interconnecting all of the components of the camera system. A description of the general features and functionality of the display 810, keyboard and/or mouse 814, as well as the display controller 808, storage controller 824, network controller 806, sound controller 820, and general purpose I/O interface 812 is omitted herein for brevity as these features are known.

Numerous modifications and variations of the present invention are possible in light of the above teachings. It is therefore to be understood that within the scope of the appended claims, the invention may be practiced otherwise than as specifically described herein.

1. A camera viewing system, comprising:
a first array of cameras distributed atop a carrier, configured to record or stream video content about a radial view of the carrier;
a second array of cameras distributed about a first side of the carrier, configured to record or stream video content from a front and back first side view of the carrier;
a third array of cameras distributed about a second side of the carrier, configured to record or stream video content from a front and back second side view of the carrier;
a router configured to route the recorded and streamed video content to the carrier;
a transmitter configured to transmit the recorded and streamed video content to a satellite for routing to a receiver for subsequent display away from the carrier; and
a plurality of displays configured to receive camera manipulation instructions from multiple parties and display associated results, via respective graphical user interfaces (GUIs).

2. The camera viewing system of claim 1, further comprising:
a fourth array of cameras distributed about a bottom side of the carrier, wherein one of the cameras of the fourth array of cameras is aimed downwards from the carrier.

3. The camera viewing system of claim 2, wherein the carrier is an aircraft.

4. The camera viewing system of claim 1, wherein the carrier is one of a train, a water vessel, or a bus.

5. The camera viewing system of claim 1, wherein one or more cameras of the first array of cameras, or the second array of cameras, or the third array of cameras are dedicated cameras for monitoring weather conditions or natural phenomena.

6. The camera viewing system of claim 1, wherein the received camera manipulation instructions include one or more of camera direction, camera zoom, live streaming of the video content, or display of recorded video content.

7. The camera viewing system of claim 1, wherein the respective GUIs are configured to receive the camera manipulation instructions from one or more of passengers, carrier personnel, and remote carrier personnel.

8. A redundant camera viewing system, comprising:
a first array of cameras distributed atop a carrier, configured to record or stream video content about a radial view of the carrier;
a second array of cameras distributed about a first side of the carrier, configured to record or stream video content from a front and back first side view of the carrier;
a third array of cameras distributed about a second side of the carrier, configured to record or stream video content from a front and back second side view of the carrier; and
a router configured to route the recorded and streamed video content to the carrier,
wherein the first, second, and third arrays of cameras contain multiple cameras directed towards a similar viewing area, and are configured to capture duplicate video content and assign to individual viewers.

9. The redundant camera viewing system of claim 8, further comprising:
a transmitter configured to transmit the recorded and streamed video content to a satellite for routing to a receiver for subsequent display remote from the carrier.

10. The redundant camera viewing system of claim 8, further comprising:
a fourth array of cameras distributed about a bottom side of the carrier, wherein one or more of the cameras of the fourth array of cameras is directed downwards from the carrier.

11. The redundant camera viewing system of claim 10, wherein the first, second, third, and fourth arrays of cameras are further configured to record or display photographs about multiple views of the carrier.

12. The redundant camera viewing system of claim 11, wherein some of the multiple cameras directed towards a similar viewing area are configured for carrier personnel use or for carrier passenger use.

13. The redundant camera viewing system of claim 12, wherein some of the multiple cameras directed towards a similar viewing area are configured for use by one or more of an advertising agency, a news agency, a law enforcement agency, or a weather agency.

14. The redundant camera viewing system of claim 8, wherein the cameras are assigned to particular viewers based on priority resulting from at least one of payment, repeat travel with the same carrier, and booking order.

15. A method of displaying video content to passengers or personnel of a carrier, the method comprising:
receiving live or recorded video content captured from a plurality of arrays of cameras located about a top and one or more sides of a carrier;
routing the video content to display screens within the carrier for viewing by the passengers or the personnel of the carrier;
receiving instructions to manipulate one or more of the cameras from the passengers or the personnel of the carrier, via one or more graphical user interfaces (GUIs);
sending results of the received instructions to the passengers or the personnel of the carrier on a priority basis; and
displaying the results of the received instructions onto the respective GUIs.

16. The method of claim 15, further comprising:
receiving live or recorded video content captured from a plurality of arrays of cameras located on a bottom surface of the carrier.

17. The method of claim 15, further comprising:
receiving live or recorded duplicate video content from multiple cameras; and
receiving independent instructions to manipulate the multiple cameras from multiple passengers or personnel of the carrier.

18. The method of claim 17, further comprising:
receiving independent instructions to manipulate the multiple cameras from one or more of an advertising agency, a news agency, a law enforcement agency, or a weather agency.

19. The method of claim 15, wherein the instructions to manipulate one or more of the cameras include causing the camera to record particular landmarks or advertising billboards during a travel path of the carrier.

20. The method of claim 15, wherein the received instructions include one or more of changing a camera direction, zooming a camera in or out, streaming of live video content, or displaying recorded video content.
